(19) United States
(12) Patent Application Publication
(10) Pub. No.: US 2006/0178039 A1
(43) Pub. Date: Aug. 10, 2006

(54) Method for connecting a therminal to a connector and structure of the terminal

(76) Inventor: Ying Chung Chen, Pan Chiao City (TW)

Correspondence Address: LIN & ASSOCIATES INTELLECTUAL PROPERTY, P.O. BOX 2339, SARATOGA, CA, 95070-0339, US

(21) Appl. No.: 11/274,020

(22) Filed: Nov. 15, 2005

(30) Foreign Application Priority Data
Feb. 5, 2005 (TW) 094103913

(51) Int. Cl. H01R 12/24

(52) U.S. Cl. 439/495

(57) ABSTRACT

A connector includes a passage defined in a rear end thereof and a cover is pivotably connected to the connector. A plurality of engaging teeth are defined in an underside of the cover and an axle is located between the engaging teeth. A terminal has a base from which a first arm, a second arm and a contact arm extend. The contact arm has a terminal contact end at a distal end thereof and the first arm and the second arm each have a notch. The terminal extends through the passage and the axle of the cover is engaged with the notches of the terminal. By the notches, the cover is positioned and does not disengaged from the notches when pivoting relative to the connector.

### FIELD OF THE INVENTION

The present invention relates to a method for connecting a terminal to a connector and the structure of the terminal which includes clamping recesses for holding the axle of the connector.

### BACKGROUND OF THE INVENTION

A conventional way of connection of the terminal 30 and the connector 10 is disclosed in FIGS. 1A and 1B, wherein the connector 10 includes a passage defined in a rear end thereof and two engaging recesses are defined in two ends of the connector 10. A cover 12 including two positioning rods is connected to the connector 10 by engaging the positioning rods into the engaging recesses so that the cover 12 is pivotable about the positioning rods. A plurality of engaging teeth 12a are defined in an underside of the cover 12. A space is defined between the passage an the engaging recesses so that a flatcable can be inserted into the space and the cover 12 is then closed to let the line contact ends be in contact with the terminal contact ends.

Referring to FIG. 2, the cover 12 includes an axle 12b which is located between the engaging teeth 12a so that when the terminal 30 extends through the passage, an arm 30c is engaged with the axle 12b of the cover 12.

As shown in FIG. 3A, the arm 30c extends through the passage. However, when the cover 12 is pivoted to its open position as shown in FIG. 3B, because there is no securing device between the arm 30c and the axle 12b, so that the axle 12b of the cover 12 could slip away from the arm 30c. After the flatcable 40 is inserted into the space as shown in FIG. 3C, the cover 12 is pivoted downward to its close position and the axle 12b of the cover 12 is disengaged from the arm 30c as shown in FIG. 3D. This results in disqualified contact between the line contact ends and the terminal contact ends. Besides, if the flatcable 40 includes multiple line contact ends, the disqualified contact will generate high temperature which deforms the cover 12.

The present invention intends to provide a structure of a terminal which is able to securely hold the axle of the cover so that the cover is not disengaged from the terminal to ensure that the line contact ends are firmly in contact with the terminal contact ends.

### SUMMARY OF THE INVENTION

The present invention relates to a connector which includes a passage defined in a rear end thereof and two engaging recesses are defined in two ends of the connector. A cover has two positioning rods on two ends thereof and the positioning rods are engaged with the engaging recesses. A plurality of engaging teeth are defined in an underside of the cover and an axle is located between the engaging teeth. A terminal has a base and a first arm, a second arm and a contact arm extend from the base. The contact arm has a terminal contact end at a distal end thereof. The first arm and the second arm each have a notch. The axle of the cover is engaged with the notches of the first and second arms when the terminal extends through the passage of the connector.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1A shows a conventional connector with a cover;

FIG. 1B shows the cover is pivoted to its open position relative to the connector in FIG. 1A;

FIG. 2 shows that a conventional terminal is inserted into the connector;

FIG. 3A is a cross sectional view to show that the conventional terminal is inserted into the connector;

FIG. 3B is a cross sectional view to show that the cover is pivoted and the axle is slightly disengaged from the conventional terminal;

FIG. 3C shows that the axle is removed from the conventional terminal when the cover is pivoted to its close position;

FIG. 3D shows that the axle is completely disengaged from the conventional terminal when the cover is closed;

FIG. 4 shows the terminal of the present invention;

FIGS. 5A to 5C show three steps that that the terminal of the present invention is inserted into the connector, and the axle is engaged with the notches of the arms of the terminal of the present invention;

FIG. 6A shows that the cover is pivoted upward and a flatcable is to be inserted into the connector;

FIG. 6B shows that the cover is pivoted downward and the axle is engaged with the notches of the arms of the terminal, and

FIG. 6C shows that the cover is completely closed and the axle is still engaged with the notches of the arms of the terminal.

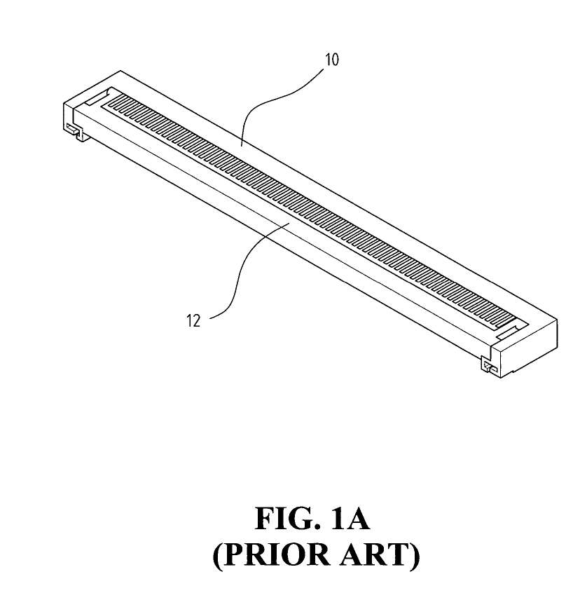

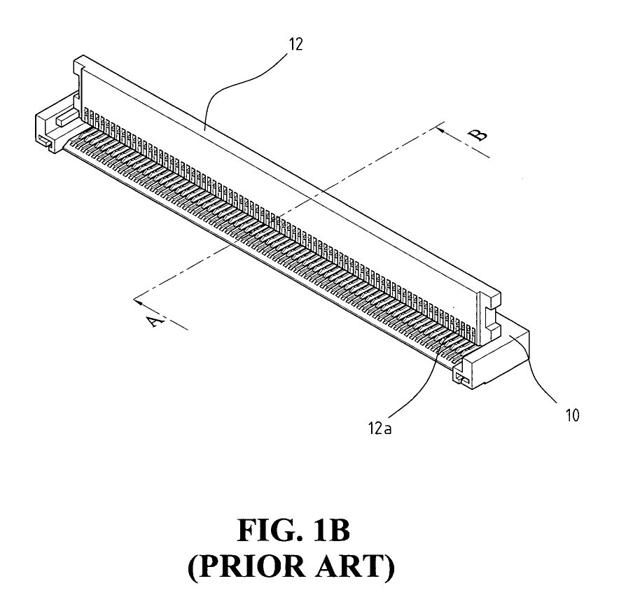

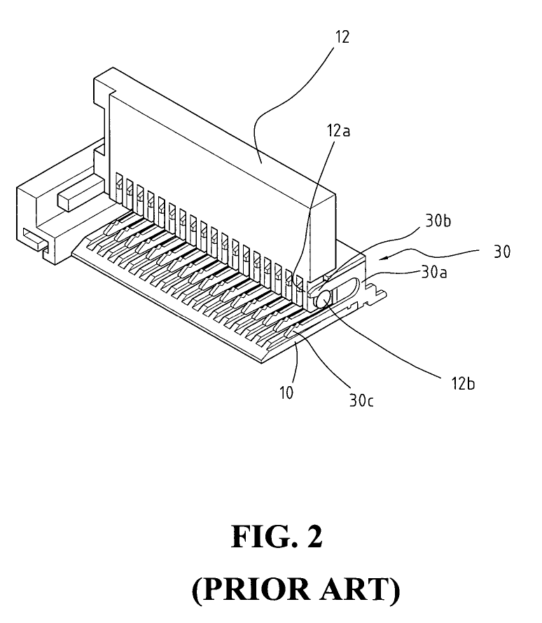

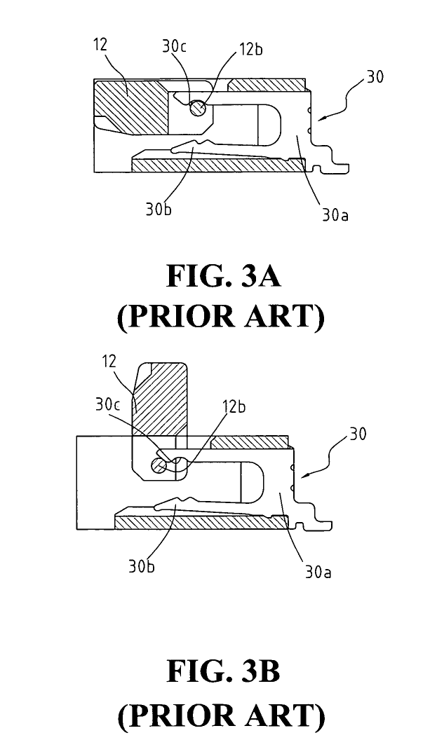

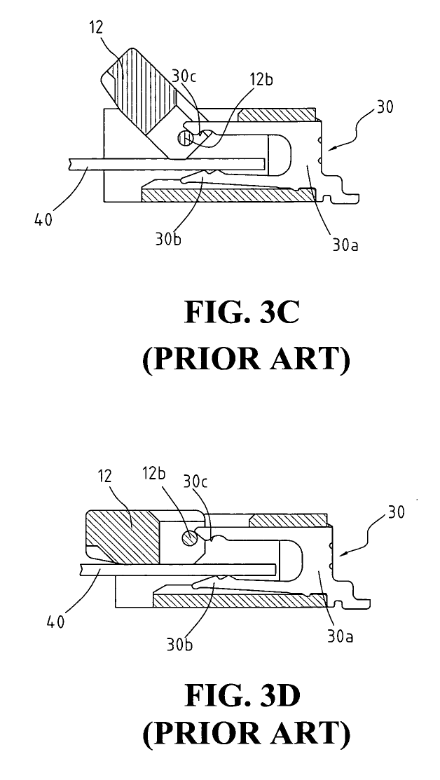

### DETAILED DESCRIPTION OF THE PREFERRED EMBODIMENT

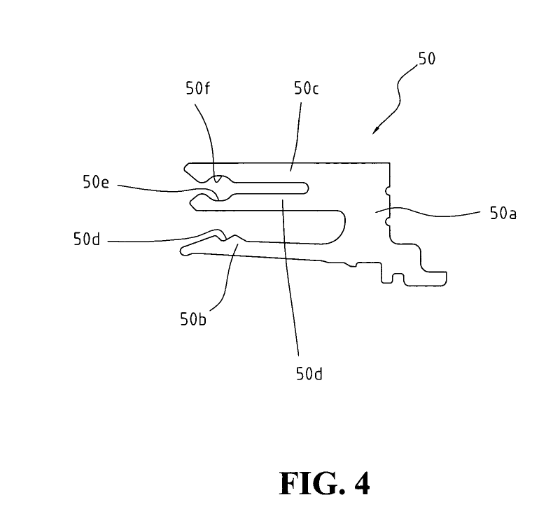

Referring to FIG. 4, the terminal 50 of the present invention is a metal plate and includes a base 50a from which a first arm 50c, a second arm 50d and a contact arm 50b extend. The contact arm 50b has a terminal contact end at a distal end thereof. The first arm 50c and the second arm 50d each have a notch 50e/50f defined in an inside thereof and the two notches 50e and 50f face to each other.

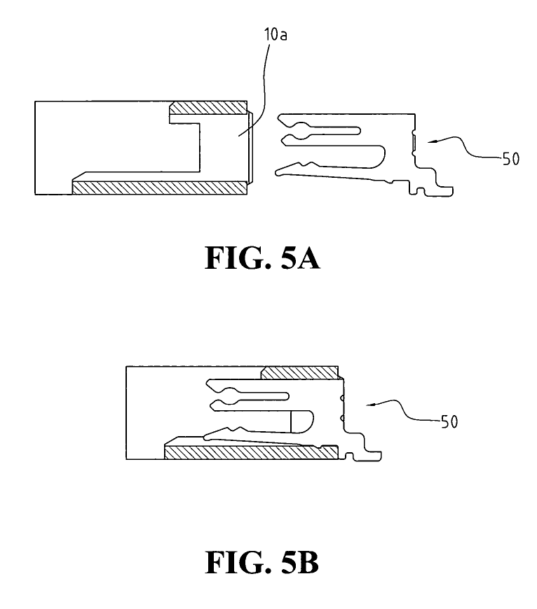

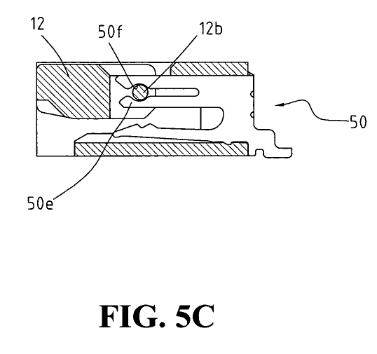

A connector 10 includes a passage l0a (FIG. 5a) defined in a rear end thereof and two engaging recesses are defined in two ends of the connector 10.

As shown in FIGS. 5A and 5B, the terminal 50 extends through the passage 10a of the connector 10. Then a cover 12 is pivotably connected to the connector 10. The cover 12 has two positioning rods on two ends thereof and the positioning rods are engaged with the engaging recesses of the connector 10 so that the cover 12 can be pivotably connected to the connector 10. A plurality of engaging teeth 12a are defined in an underside of the cover 12 and an axle 12b is located between the engaging teeth 12a. The terminal 50 can also be inserted into the connector 10 after the cover 12 is pivotally connected to the connector 10.

As shown in FIG. 5C, the axle 12b of the cover 12 is engaged with the notches 50f and 50e of the first and second arms 50c and 50d. The axle 12b is then enclosed by the notches 50f and 50e of the first and second arms 50c and 50d. Because the terminal is a metal plate so that the first arm 50c and the second arm 50d are expanded outward by the axle 12b before the axle 12b is not completely engaged with the two notches 50f and 50d. After the axle 12b is completely engaged with the two notches 50f and 50d, the first and second arms 50c and 50d bounce back to their original positions and the axle 12b is held by the first and second arms 50c and 50d.

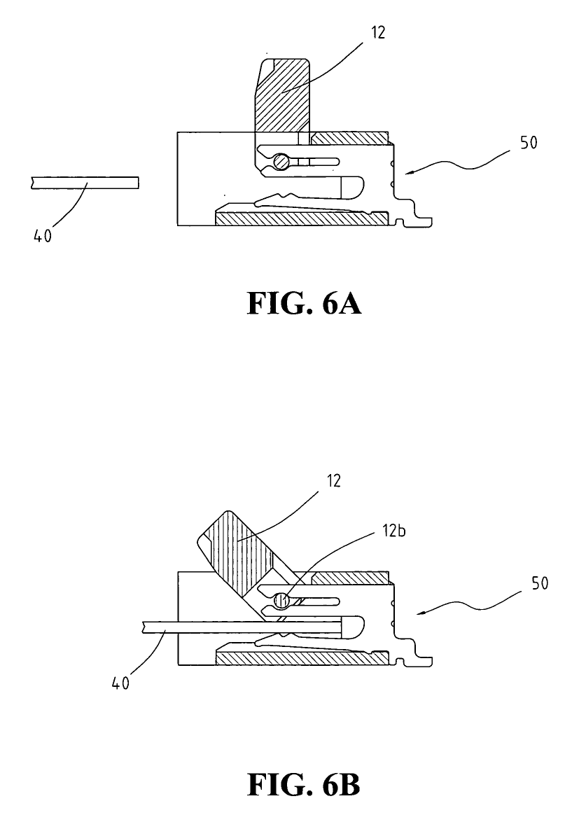

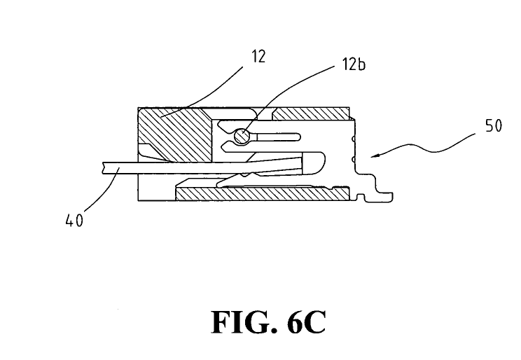

Referring to FIGS. 6A to 6C, the cover 12 is first pivoted upward to its open position and the flatcable 40 is inserted into the space defined between the passage and the engaging recesses of the connector 10. The cover 12 is then pivoted downward to its close position and the flatcable 40 has line contact ends which are in contact with the terminal contact end of the terminal 50. Because the cover 12 I swell positioned so that the contact between the flatcable 40 and the terminal 50 is reliable and satisfied.

While we have shown and described the embodiment in accordance with the present invention, it should be clear to those skilled in the art that further embodiments may be made without departing from the scope of the present invention.

What is claimed is:

1. A method for connecting a terminal to a connector comprising the following steps:
providing a connector which includes a passage defined in a rear end thereof and two engaging recesses are defined in two ends of the connector;
providing a cover having two positioning rods on two ends thereof, the positioning rods being engaged with the engaging recesses, a plurality of engaging teeth defined in an underside of the cover and an axle located between the engaging teeth;
providing a terminal which has a base from which a first arm, a second arm and a contact arm extend, the contact arm having a terminal contact end at a distal end thereof, the first arm and the second arm each having a notch;
the terminal extending through the passage of the connector and the cover being pivotably connected to the connector by engaging the positioning rods of the cover with the engaging recesses of the connector, the first arm and the second arm being in contact with the axle and being expanded outward by the axle, and the axle being enclosed by the two notches.

2. The method as claimed in claim 1, wherein a space is defined between the passage and the engaging recesses of the connector.

3. The method as claimed in claim 2 further comprising the following steps:
pivoting the cover to its open position and inserting a flatcable into the space, and
pivoting the cover to its close position and the flatcable having line contact ends which are in contact with the terminal contact end of the terminal.

4. The method as claimed in claim 1, wherein the terminal is a metal plate.

5. A method for connecting a terminal to a connector comprising the following steps:
providing a connector which includes a passage defined in a rear end thereof and two engaging recesses are defined in two ends of the connector;
providing a cover having two positioning rods on two ends thereof, the positioning rods being engaged with the engaging recesses, a plurality of engaging teeth defined in an underside of the cover and an axle located between the engaging teeth;
providing a terminal which has a base from which a first arm, a second arm and a contact arm extend, the contact arm having a terminal contact end at a distal end thereof, the first arm and the second arm each having a notch;
the positioning rods of the cover being engaged with the engaging recesses of the connector;
the terminal extending through the passage of the connector, the first arm and the second arm being in contact with the axle and being expanded outward by the axle, and
the axle being enclosed by the two notches.

6. The method as claimed in claim 5, wherein a space is defined between the passage and the engaging recesses of the connector.

7. The method as claimed in claim 6 further comprising the following steps:
pivoting the cover to its open position and inserting a flatcable into the space, and
pivoting the cover to its close position and the flatcable having line contact ends which are in contact with the terminal contact end of the terminal.

8. The method as claimed in claim 5, wherein the terminal is a metal plate.

9. A combination of a terminal and a connector wherein the connector includes a passage defined in a rear end thereof and two engaging recesses are defined in two ends of the connector;
a cover has two positioning rods on two ends thereof and the positioning rods are engaged with the engaging recesses, a plurality of engaging teeth are defined in an underside of the cover and an axle is located between the engaging teeth, and
the terminal has a base from which a first arm, a second arm and a contact arm extend, the contact arm has a terminal contact end at a distal end thereof, the first arm and the second arm each have a notch, the axle of the cover is engaged with the notches of the first and second arms and when the terminal extends through the passage of the connector.

10. The method as claimed in claim 9, wherein the terminal is a metal plate.

11. The method as claimed in claim 9, wherein a space is defined between the space, the flatcable has line contact ends which are in contact with the terminal contact end of the terminal.
